(19) United States
(12) Patent Application Publication
(10) Pub. No.: US 2009/0009913 A1
(43) Pub. Date: Jan. 8, 2009

(54) MAGNETO-RESISTANCE ELEMENT, MANUFACTURING METHOD THEREFOR, AND MAGNETIC HEAD

(75) Inventor: Kojiro Komagaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/164,493

(22) Filed: Jun. 30, 2008

(30) Foreign Application Priority Data
Jul. 3, 2007 (JP) 2007-174767

(51) Int. Cl. G11B 5/33

(52) U.S. Cl. 360/319; 360/324.2

(57) ABSTRACT

A tunneling magneto-resistance element has a pinned magnetic layer, a free magnetic layer, a tunnel barrier layer interposed between the pinned magnetic layer and the free magnetic layer, an antiferromagnetic layer that pins a magnetization direction of the pinned magnetic layer, a lower shield layer under the antiferromagnetic layer and a seed layer under the lower shield layer. The lower shield layer causes the antiferromagnetic layer to be oriented in a plane orientation direction that causes a unidirectional anisotropy of the antiferromagnetic layer to be improved. The seed layer causes the lower shield layer to be oriented in a plane orientation direction identical to the plane orientation direction of the antiferromagnetic layer. The gap thickness in the read head can be reduced without impairing the effect of pinning by an antiferromagnetic layer with a pinned magnetic layer.

### CROSS-REFERENCE TO RELATED APPLICATION

This application is based upon and claims the benefit of priority of the prior Japanese Patent Application No. 2007-174767, filed on Jul. 3, 2007, the entire contents of which are incorporated herein by reference.

### BACKGROUND

1. Field

An aspect of the invention is related to a magneto-resistance element which may includes a TMR (tunneling magneto-resistance) element, a manufacturing method therefore and a magnetic head including a read head formed from a TMR magneto-resistance element.

2. Description of the Related Art

Some magnetic storage apparatuses have magnetic heads formed from TMR read elements. The TMR read element is formed from a magneto-resistance element including a tunnel barrier layer, to read magnetic information by passing a sense current along a thickness direction of the magneto-resistance element.

FIG. 8 shows an exemplary magneto-resistance element 10 that is a TMR read element. The magneto-resistance element 10 is formed of multiple layers laminated on a substrate 11. There are laminated thereon a seed layer 12, a lower shield layer 13, an underlayer 14, an antiferromagnetic layer 15, a pinned magnetic layer 16, a tunnel barrier layer 17, a free magnetic layer 18, a cap layer 19, and an upper shield layer 20 in that order.

The lower shield layer 13 and upper shield layer 20 are, respectively, magnetic shields, and concurrently work as electrodes that pass the sense current along the thickness direction to a TMR layer. The lower shield layer 13 and upper shield layer 20 are formed of a soft magnetic material, such as NiFe, for example. The seed layer 12 is a conductive layer necessary to form the lower shield layer 13 through electrolytic plating. The seed layer 12 is formed by sputtering NiFe, for example, onto the surface of the substrate 11.

The underlayer 14, which is formed on the lower shield layer 13, is provided to cause the antiferromagnetic layer 15 to be preferentially oriented along the direction of a predetermined crystal plane. Unidirectional anisotropy of the antiferromagnetic layer 15 is increased, and the operation of exchange coupling between the antiferromagnetic layer 15 and the pinned magnetic layer 16 is increased, thereby to make it possible to pin the pinned magnetic layer 16 strongly by using the antiferromagnetic layer 15. The antiferromagnetic layer 15 is formed by use of an antiferromagnetic material, such as IrMn. For example, IrMn has a crystal structure in the form of a face centered cubic lattice, and is deposited to orient along the (111) plane direction, thereby making it possible to increase the unidirectional anisotropy. First, the underlayer 14 to be formed to have an orientation direction corresponding to the (111) plane direction is deposited, and then the antiferromagnetic layer 15 is deposited thereon. The antiferromagnetic layer 15 is preferentially oriented in the orientation direction corresponding to the (111) plane direction.

Japanese Laid-open Patent Publication 2001-297913 discloses a method of providing an underlayer on which an antiferromagnetic layer are preferentially oriented in the specific crystal planes direction in order to improve the unidirectional anisotropy of the antiferromagnetic layer. In the case where IrMn is used as an antiferromagnetic material, a material, such as NiFe or Ta/NiFe, is used for the underlayer.

In association with enhancement in density of magnetic storage apparatuses, the read head of the magnetic head needs size reduction (miniaturization) and gap thickness reduction. The gap of the read head corresponds to the distance between the lower shield layer 13 and the upper shield layer 20, or more specifically, a total layer thickness from the underlayer 14 to the cap layer 19. Accordingly, when the underlayer 14 is provided to improve the unidirectional anisotropy of the antiferromagnetic layer 15, the gap thickness is increased by the thickness of the underlayer 14.

The layer thickness of the TMR magneto-resistance element varies even depending upon, for example, materials and layer configurations. For example, the thicknesses of the respective layers are: the underlayer=5 nm; the antiferromagnetic layer=7 nm; the pinned magnetic layer=5 nm; the tunnel barrier layer=1 nm; the free magnetic layer=4 nm; and the cap layer=5 nm. As above, the layer thickness of the underlayer 14 occupies about 20% of the total layer thickness of the magneto-resistance element. Hence, if there was a method capable of causing the antiferromagnetic layer 15 to be preferentially orientated along the crystal plane direction that causes the unidirectional anisotropy to be improved without using the underlayer 14, the method would be very effective for reducing the gap thickness in the read head.

### SUMMARY

Accordingly, it is an object of the embodiment to provide a magneto-resistance element that is capable of effectively contributing to densification of a magnetic storage apparatus in accordance with the inventive technique.

According to an aspect of an embodiment, a tunneling magneto-resistance element has a pinned magnetic layer, a free magnetic layer, a tunnel barrier layer interposed between the pinned magnetic layer and the free magnetic layer, an antiferromagnetic layer that pins a magnetization direction of the pinned magnetic layer, a lower shield layer under the antiferromagnetic layer and a seed layer under the lower shield layer. The lower shield layer causes the antiferromagnetic layer to be oriented in a plane orientation direction that causes a unidirectional anisotropy of the antiferromagnetic layer to be improved. The seed layer causes the lower shield layer to be oriented in a plane orientation direction identical to the plane orientation direction of the antiferromagnetic layer.

According to another aspect of an embodiment, a tunneling magneto-resistance element has a pinned magnetic layer, a free magnetic layer, a tunnel barrier layer interposed between the pinned magnetic layer and the free magnetic layer, an antiferromagnetic layer that pins a magnetization direction of the pinned magnetic layer and a lower shield layer under the antiferromagnetic layer. The lower shield layer includes a sputter layer section and a lower-shield main section. The sputter layer section is provided in contact with the antiferromagnetic layer and causes the antiferromagnetic layer to be oriented in a plane orientation direction that causes a unidirectional anisotropy of the antiferromagnetic layer to be improved. The lower-shield main section is provided under the sputter layer section and is formed of the same soft magnetic material as the sputter layer section.

### BRIEF DESCRIPTION OF DRAWINGS

The present invention will be explained with reference to the accompanying drawings.

FIG. 1 is an explanatory view showing the configuration of a magneto-resistance element according to a first embodiment of the present invention;

FIG. 2 is an explanatory view showing the configuration of a magneto-resistance element according to a second embodiment of the present invention;

FIG. 3 is a graph showing the results obtained in the event that the strength rate between in the (200) plane direction and in the (111) plane direction in a NiFe plating layer were measured by changing the plating layer thickness;

FIG. 4 is a cross sectional view showing the configuration of a read head including a magneto-resistance element according to one embodiment of the present invention;

FIG. 5 is a cross sectional view showing the configuration of the magnetic head including the magneto-resistance element according to one embodiment of the present invention;

FIG. 6 is a perspective view of a head slider including a magnetic head according to the first embodiment of the present invention;

FIG. 7 is a plan view showing the overall configuration of a magnetic storage apparatus including the magnetic head according to the first embodiment of the present invention; and

FIG. 8 is an explanatory view showing the configuration of a conventional magneto-resistance element.

### DETAILED DESCRIPTION OF THE PREFERRED EMBODIMENTS

Embodiments of the present invention will be described in detail below with reference to the accompanying drawings.

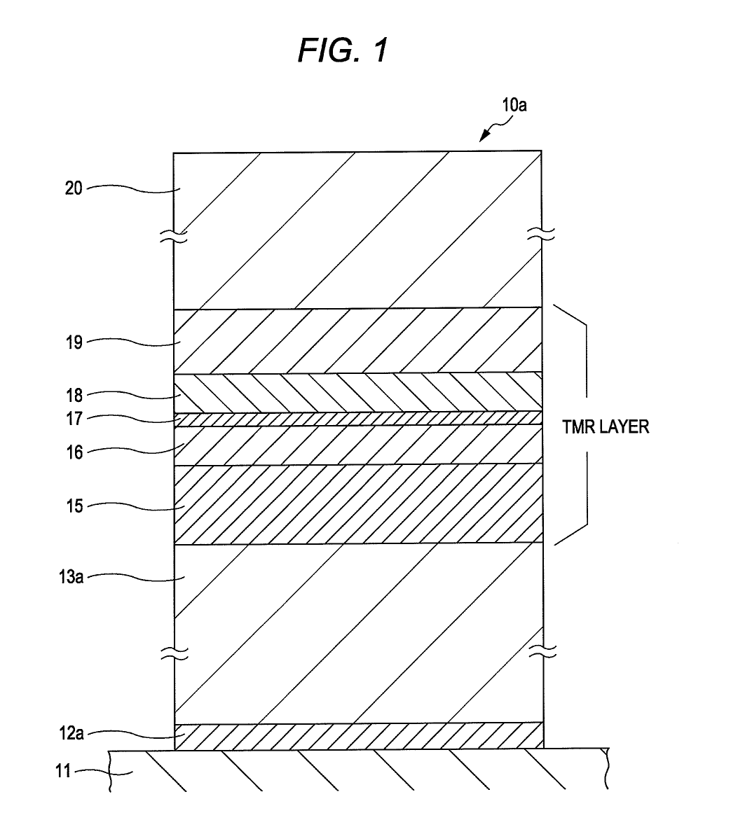

(Magneto-Resistance Element: First Embodiment) FIG. 1 is an explanatory view showing the configuration of a magneto-resistance element 10a according to a first embodiment of the present invention. The magneto-resistance element 10a is formed of multiple layers laminated on a substrate 11. There are laminated a seed layer 12a, a lower shield layer 13a, an antiferromagnetic layer 15, a pinned magnetic layer 16, a tunnel barrier layer 17, a free magnetic layer 18, a cap layer 19, and an upper shield layer 20 in that order. The magneto-resistance element 10a of the present embodiment is a TMR magneto-resistance element, in which the antiferromagnetic layer 15, the pinned magnetic layer 16, the tunnel barrier layer 17, the free magnetic layer 18, and the cap layer 19 correspond to a TMR layer. The lower and upper shield layers 13a and 20 are, respectively, magnetic shields, and concurrently work as electrodes that pass the sense current in the thickness direction to the TMR layer.

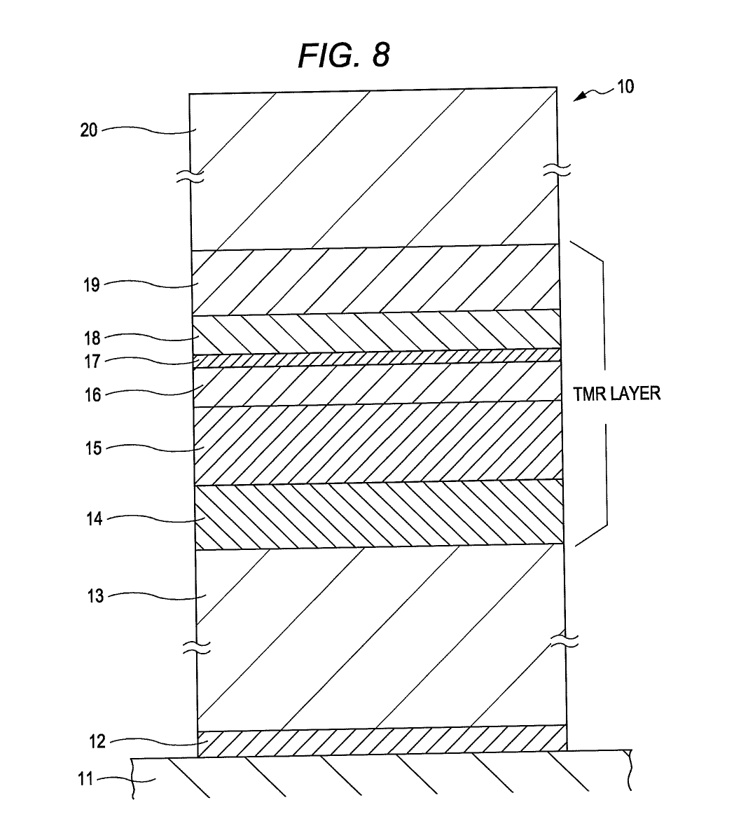

A feature of the magneto-resistance element 10a is that there is no underlayer 14 under the antiferromagnetic layer 15, as in the conventional configuration of the magneto-resistance element 10 shown in FIG. 8. As described in the RELATED ART section above, the underlayer 14 is provided to improve the unidirectional anisotropy of the antiferromagnetic layer 15. In the case where a material, such as, for example, IrMn, is used in the antiferromagnetic layer 15, it has to be deposited so that an fcc (111) plane direction of IrMn, which has a crystal structure in the form of a face centered cubic (fcc) lattice, is the orientation direction, in order to improve the unidirectional anisotropy. Since the underlayer 14 is thus oriented in the fcc (111) plane direction, the antiferromagnetic layer 15 can be preferentially oriented in the fcc (111) plane direction. The fcc (111) plane direction and the fcc (200) plane direction, respectively, will be referred to simply as “(111) plane direction” and “(200) plane direction,” herebelow.

The underlayer 14 is used (in the conventional configuration) to cause a crystal plane of the antiferromagnetic layer 15 to be oriented in the (111) plane direction. As such, if the lower shield layer 13a, which is formed in the position corresponding to the position under the underlayer 14, can be oriented in the (111) plane direction, the underlayer 14 does not have to be provided.

According to the featured configuration of the magneto-resistance element 10a of the present embodiment, the underlayer 14 (in the conventional configuration) is omitted, and concurrently, the lower shield layer 13a, which is used as an underlayer of the antiferromagnetic layer 15, is deposited to be oriented in the (111) direction. With deposition of the antiferromagnetic layer 15 on the lower shield layer 13a, the antiferromagnetic layer 15 can be preferentially oriented in the (111) plane direction.

The lower shield layer 13a, generally, can be made by plating. In order to preferentially orient the lower shield layer 13a in the (111) plane direction, first, the seed layer 12a, which is an underlayer of the lower shield layer 13a, is oriented in the (111) plane direction. Then, the lower shield layer 13a is plated on the seed layer 12a.

NiFe, which is a soft magnetic material, is generally used for the lower shield layer 13a. The orientation direction of NiFe is the (111) plane direction. The lower shield layer 13a can be formed to be oriented in the (111) plane direction in such a manner that the lower shield layer 13a is formed on the seed layer 12a, which is oriented in the (111) plane direction.

The material usable to form the seed layer 12 that is preferentially oriented in the (111) plane direction can be selected from among Ta, Ti, Ru, NiFe, NiCr, and Cu. These materials each may be used alone, or a laminate of plural different materials may be sued as the seed layer 12a.

A problem in forming the lower shield layer 13a is that the lower shield layer 13a has a significantly large thickness in comparison to the respective layers constituting the TMR layer. Hence, even when the seed layer 12 is oriented in the (111) plane direction, there still remains a problem regarding whether an upper portion of the lower shield layer 13a is oriented in the (111) plane direction.

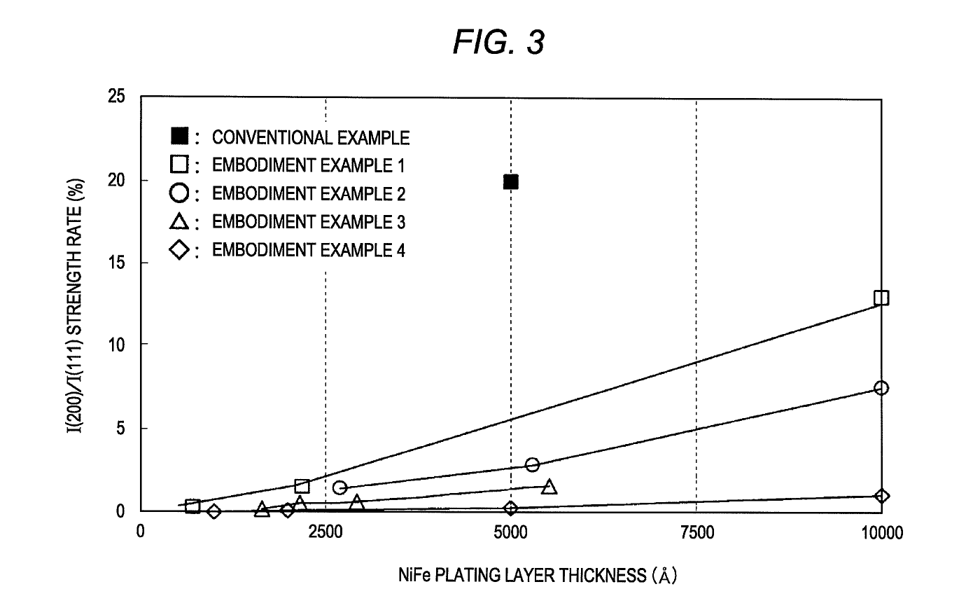

FIG. 3 shows the results in the event that the strength rate between in the (200) plane direction and in the (111) plane direction formed on the seed layer using electrolytic plating was measured by changing the plating layer thickness. More specifically, the graph of FIG. 3 shows the measurement results in the cases where the conventional seed layer 12 and the seed layer 12a of the present embodiment are used. In the case of the NiFe plating layer, the strength in the (200) plane direction appears subsequent to the (111) plane direction, so that the strength rates were measured by changing the plating layer thickness.

More particularly, in the graph of FIG. 3, “Conventional Example” shows the result when the NiFe plating layer was formed with the seed layer 12 set as Ta (50 Angstroms)/NiFe (500 Angstroms); “Embodiment Example 1” shows the result when the NiFe plating layer was formed with the seed layer 12a set as Ta (50 Angstroms)/Ru (500 Angstroms); “Embodiment Example 2” shows the result when the seed layer 12a was set as Ta (50 Angstroms)/NiFe (500 Angstroms); “Embodiment Example 3” shows the result when the seed layer 12a was set as NiCr (50 Angstroms)/NiFe (500 Angstroms); and “Embodiment Example 4” shows the result when the seed layer 12a was set as Ta (50 Angstroms)/NiCr (500 Angstroms). In each of the cases (Conventional Example and Embodiment Examples 1 to 4), the NiFe plating layer was formed on the seed layer 12 or 12a.

In Conventional Example, the vacuum degree in a sputtering chamber used for deposition of the seed layer 12 was set to 10⁻⁴ Pa; and in each of Embodiment Examples 1 to 4, the vacuum degree in a sputtering chamber used for deposition of the seed layer 12a was set to 10⁻⁶ Pa.

According to the experimentation result, the case where the conventional seed layer 12 was used (in “Conventional Example in the graph) is indicative that when the plating layer thickness is about 5000 Angstroms, an orientation field in the (200) plane direction is mixed in an amount corresponding to about 20% of the orientation field in the (111) plane direction. More specifically, when the NiFe plating layer is formed as the lower shield layer 13 by use of the conventional seed layer 12, the NiFe plating layer mixedly contains not only the orientation field in the (111) plane direction, but also a large amount of the orientation field in the (200) plane direction. As such, it cannot be said that the effect of causing the antiferromagnetic layer 15 to be oriented in the (111) plane direction is sufficient. This is the reason that the underlayer 14 for the antiferromagnetic layer 15 is conventionally provided. The rate between the strength in the (200) plane direction and (111) plane direction of the lower shield layer 13 influences the orientation in the (111) plane direction of the antiferromagnetic layer 15, and consequently influences the unidirectional anisotropy of the antiferromagnetic layer 15.

In comparison to the above, as shown in FIG. 3 as “Embodiment Examples 1 to 4,” in the case where the seed layer 12a oriented in the (111) plane direction is formed and the NiFe plating layer is formed on the seed layer 12a, the strength in the (200) plane direction in the NiFe plating layer is 10% or less than the strength in the (111) plane direction in the layer even when the thickness of the NiFe plating layer is about 10000 Angstroms. That is, the strength in the (200) plane direction is largely reduced as compared with the Conventional Example. For this reason, the NiFe plating layer is preferentially oriented in the (111) plane direction by using the seed layer 12a oriented in the (111) plane direction. Hence, the antiferromagnetic layer 15 can be controlled in orientation without using the underlayer 14. The experimentation results (shown in FIG. 3) indicate that when the thickness of the NiFe plating layer is increased, the strength in the (200) plane direction is also increased.

In the experimentation, the vacuum degree inside the sputtering chamber used for deposition of the seed layer 12 in the Conventional Example was formed was set to 10⁻⁴ Pa. In Embodiment Example 2, the vacuum degree inside the sputtering chamber used for deposition of the seed layer 12a, which has the same configuration as in Conventional Example, was set to 10⁻⁶ Pa. The experiment results indicate that, in the case of deposition of the seed layer by the sputtering process, the vacuum degree in the sputtering chamber causes the seed layer to be accurately oriented to a predetermined crystal plane direction. The experiment results further indicate that it is effective to set the vacuum degree inside the sputtering chamber to 10⁻⁶ Pa or lower (higher vacuum than 10⁻⁶ Pa) in order to improve the orientation accuracy.

The magneto-resistance element 10a of the present embodiment has a feature in the configuration of the underlayer, that is, the lower shield layer 13a, which causes the unidirectional anisotropy of the antiferromagnetic layer 15 to be improved. Hence, no specific limitations are imposed on the configuration of the TMR layer that constitutes the magneto-resistance element 10a. Regarding, for example, the materials of the respective layers to be used for the TMR layer and the configurations of the respective layers, various configurations have been proposed. Regardless of these configurations of the TMR layer, however, the magneto-resistance element 10a of the present embodiment can be adapted.

As examples of materials constituting the TMR layer of the magneto-resistance element 10a shown in FIG. 1, a Mn based material such as IrMn, PtMn, or PdPtMn is used for the antiferromagnetic layer 15. Further, CoFe or CoFeB is used for the pinned magnetic layer 16; MgO is used for the tunnel barrier layer 17, and CoFe or CoFeB is used for the free magnetic layer 18; and Ru is used for the cap layer 19.

The magneto-resistance element 10a of the present embodiment is configured such that the antiferromagnetic layer 15 is directly deposited on the lower shield layer 13a. The crystal plane direction of the antiferromagnetic layer 15 can be justified to the direction that causes the unidirectional anisotropy of the antiferromagnetic layer 15 to be improved. Thereby, the unidirectional anisotropy of the antiferromagnetic layer 15 is secured, and the pinning effect of the antiferromagnetic layer 15 for the pinned magnetic layer 16 can be effectively secured. Further, the configuration is formed such that the antiferromagnetic layer 15 is directly formed on the lower shield layer 13a to omit the conventional underlayer 14. Thereby, the gap thickness in a read head can be narrowed, and hence densification of the magnetic storage apparatus can be effectively accomplished.

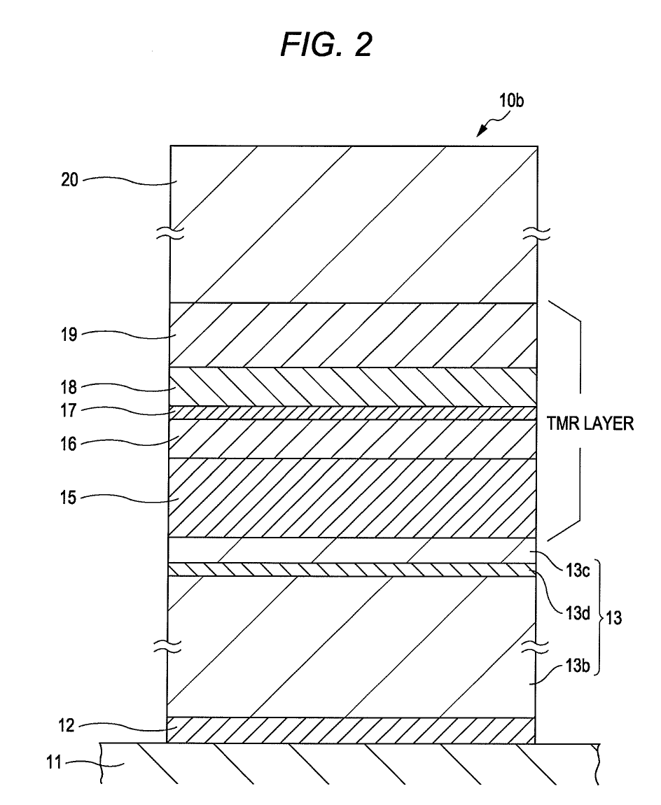

(Magneto-Resistance Element: Second Embodiment) FIG. 2 shows the configuration of a magneto-resistance element 10b according to a second embodiment of the present invention. Similar to the above, the magneto-resistance element 10b of the present embodiment is featured with the configuration in which the conventional underlayer 14 is not provided under the antiferromagnetic layer 15 constituting the TMR layer, but the antiferromagnetic layer 15 is directly formed on the lower shield layer 13.

A difference from the configuration of the first embodiment is that a sputter layer 13c is formed on a top surface of the lower shield layer 13, in which the sputter layer 13c is formed of NiFe that constitutes the lower shield layer 13. The sputter layer 13c is provided to cause the antiferromagnetic layer 15 to be preferentially a specific plane orientation direction that causes the improvement of the unidirectional anisotropy of the antiferromagnetic layer 15. In this case, sputtering is performed so that the orientation is set to the (111) plane direction.

In the present embodiment, the sputter layer 13c is deposited using NiFe. However, in order to deposit NiFe to be oriented in the (111) plane direction, it is preferable that an underlayer 13d is first deposited under the sputter layer 13c, and then the sputter layer 13c is deposited on the underlayer 13d. As the underlayer 13d, Ta or NiCr, for example, can be used. The underlayer 13d is used to justify the orientation direction of the sputter layer 13c. With deposition of the underlayer 13d to have the (111) plane direction, the orientation direction of NiFe to be deposited on the underlayer 13d can be justified to the (111) plane direction. The underlayer 13d can be formed to a thickness of about 0.2 nm. The sputter layer 13c is formed to a thickness to a range of from about several nanometers (nm) to about several tens of nanometers because the lower shield layer 13 is used to define the orientation direction of the antiferromagnetic layer 15.

The deposition conditions in the event of the sputter layer 13c and the underlayer 13d is specified so that the strength of the (200) plane direction is 10% or less than the strength of the (111) plane direction. Thereby, the unidirectional anisotropy of the antiferromagnetic layer 15 can be effectively improved. This is similar to the first embodiment.

In the present embodiment, the sputter layer 13c made of the same material as the lower shield layer 13 is formed on the surface of the lower shield layer 13. Hence, a lower-shield main section 13b, which works as an underlayer for the underlayer 13d, can be formed without considering its orientation direction. More specifically, a conventional plating seed layer formed without considering its plane orientation can be used for the seed layer 12, which works as an underlayer for the lower-shield main section 13b. The lower-shield main section 13b can be formed using electrolytic plating, similarly as in the conventional method.

The magneto-resistance element 10b of the present embodiment is thus configured in the manner that the sputter layer 13c, which is justified in its orientation to the predetermined orientation direction, is formed on the surface of the lower shield layer 13. Hence, the antiferromagnetic layer 15 can be formed to be oriented in the plane orientation direction that causes the antiferromagnetic layer 15 to be improved in the unidirectional anisotropy. Thereby, the effect of pinning the pinned magnetic layer 16 by using the antiferromagnetic layer 15 can be sufficiently secured. Further, in regard to the layers below the antiferromagnetic layer 15, since the entirety including the sputter layer 13c operates as the lower shield layer 13, the overall layer thickness of the TMR layer can be reduced. Consequently, the reduction of the gap thickness can be accomplished.

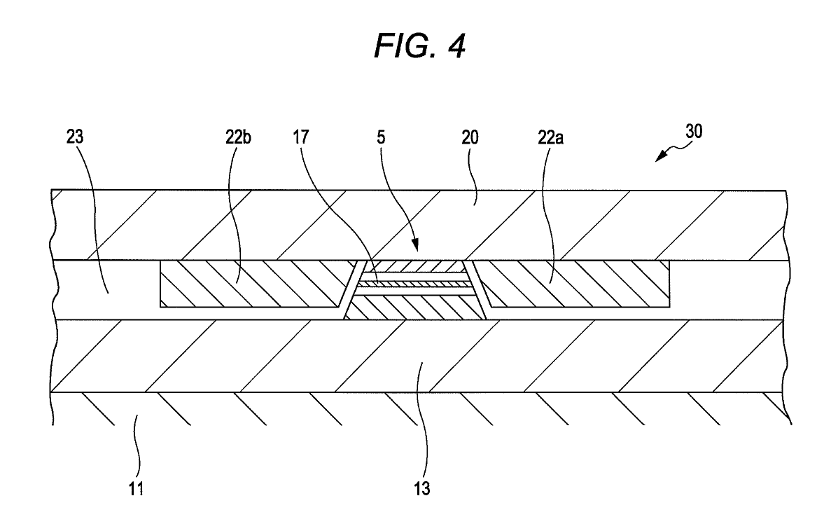

(Magnetic Head and Magnetic Storage Apparatus) FIG. 4 shows the configuration of a TMR read head 30 including a magneto-resistance element of one embodiment of the present invention, which corresponds to any one of the embodiments described above. In particular, FIG. 4 shows the configuration as viewed from the side of a flying surface (an air bearing surface (“ABS,” herebelow)) of the read head 30 formed on a magnetic head. The read head 30 is configured in the manner that a TMR layer 5 including the tunnel barrier layer 17 is disposed between the lower shield layer 13 formed on the substrate 11 and the upper shield layer 20, and hard layers 22a and 22b, respectively, are disposed on two sides of the TMR layer 5. The hard layers 22a and 22b are electrically insulated from the TMR layer 5 and the lower shield layer 13 via an insulation layer 23 made of alumina, for example.

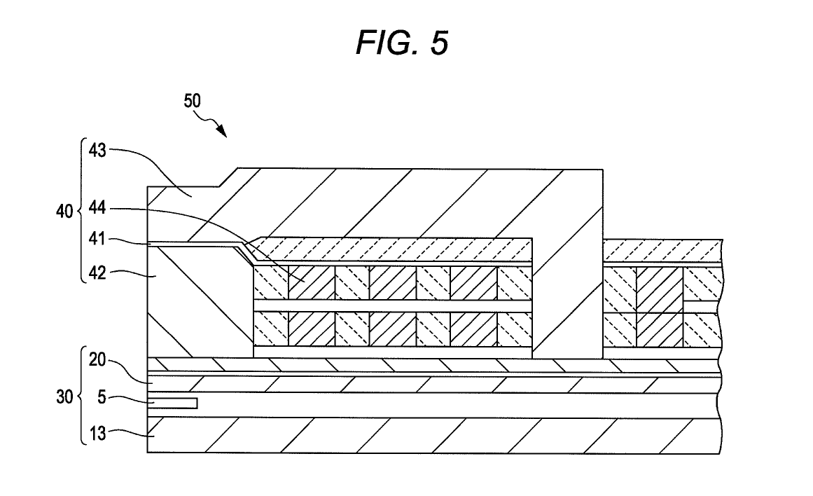

FIG. 5 shows an example of the configuration of a magnetic head 50 including the magneto-resistance element of the first embodiment of the present invention. The example magnetic head 50 shown in the figure includes a read head 30 and a write head 40. The read head 30 includes the TMR layer 5 formed between the lower shield layer 13 and the upper shield layer 20. The write head 40 includes a lower magnetic pole 42 and an upper magnetic pole 43 in positions interposing a write gap 41, and a write coil 44 disposed in such a manner as to wind around the magnetic pole 42 and the upper magnetic pole 43.

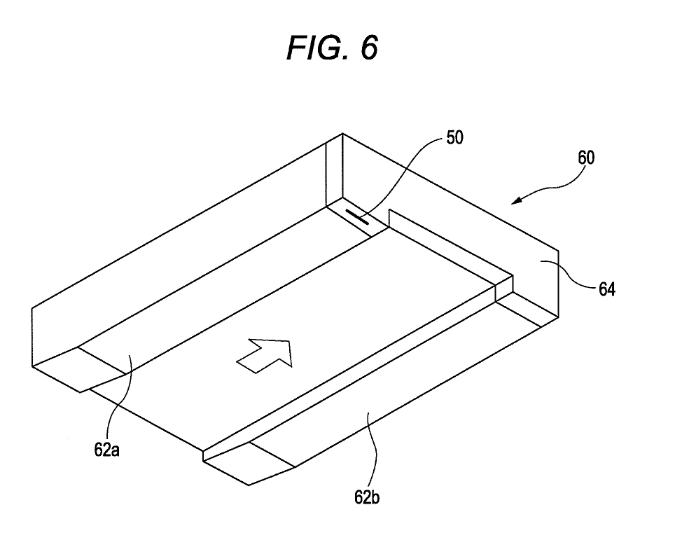

FIG. 6 shows a head slider 60 including the magnetic head 50 formed therein. Fly rails 62a and 62b are provided on the surface (ABS), which opposes a magnetic disk, of the head slider 60. The magnetic head 50 is provided on the front end side of the head slider 60 and is covered with a protection layer 64.

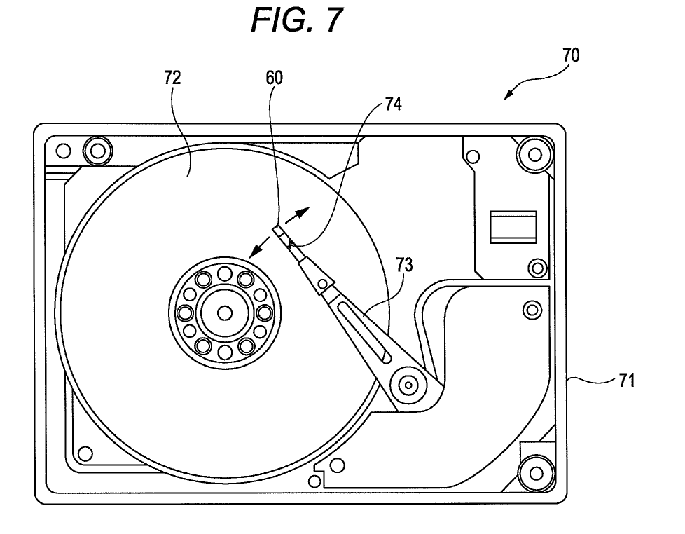

FIG. 7 shows the overall configuration of a magnetic storage apparatus 70 including the magnetic head of the first embodiment of the present invention. The magnetic storage apparatus 70 includes in a housing 71, multiple magnetic recording disks 72 that are rotationally driven by a spindle motor. A carriage arm 73 is disposed on a lateral side of the magnetic recording disk 72, a head suspension 74 is mounted to the end of the carriage arm 73, and the head slider 60 is mounted to the end of the head suspension 74.

The head slider 60 is elastically urged by the head suspension 74 towards the disk surface. When the magnetic recording disk 72 is rotated by the spindle motor, the head slider 60 is caused by air flow, which occurs with the rotation, to fly apart by a predetermined distance (height) from the disk surface. Thereby, information record (write)/read processing is performed between the magnetic head 50 and the magnetic recording disk 72.

According to the magneto-resistance element of the one embodiment of present invention, the antiferromagnetic layer is formed directly on the lower shield layer. Thereby, the conventional underlayer provided under the antiferromagnetic layer can be omitted, and the magneto-resistance element can be effectively formed to be thin. Further, the lower shield layer or the sputter layer provided on the top surface of the lower shield layer is deposited to be oriented in the plane orientation direction that causes the unidirectional anisotropy of the antiferromagnetic layer to be improved. Hence, the antiferromagnetic layer is deposited in the plane orientation direction that causes the unidirectional anisotropy of the layer to be improved. Consequently, the magneto-resistance element and the magnetic head that can be well suitably adapted to accomplish the densification of the magnetic storage apparatus without impairing the effect of pinning the pinned magnetic layer.

Accordingly the gap thickness in the read head can be reduced without impairing the effect of pinning by an antiferromagnetic layer with a pinned magnetic layer by this tunneling magneto-resistance element.

What is claimed is:

1. A tunneling magneto-resistance element, comprising:
a pinned magnetic layer;
a free magnetic layer;
a tunnel barrier layer disposed to be interposed between said pinned magnetic layer and said free magnetic layer;
an antiferromagnetic layer that pins a magnetization direction of said pinned magnetic layer;
a lower shield layer under said antiferromagnetic layer; and
a seed layer under said lower shield layer,
wherein said lower shield layer causes said antiferromagnetic layer to be oriented in a plane orientation direction that causes a unidirectional anisotropy of said antiferromagnetic layer to be improved; and
said seed layer causes said lower shield layer to be oriented in a plane orientation direction identical to the plane orientation direction of said antiferromagnetic layer.

2. A tunneling magneto-resistance element according to claim 1, wherein:
said seed layer is formed by sputtering of one or a plurality of materials selected from among Ta, Ti, Ru, NiFe, NiCr, and Cu.

3. A tunneling magneto-resistance element according to claim 1, wherein:
said antiferromagnetic layer is formed of an antiferromagnetic material capable of being improved in the unidirectional anisotropy by being oriented in a (111) plane direction of a face centered cubic lattice; and
said lower shield layer is formed in a manner that an orientation rate between a (200) plane direction and the (111) plane direction of the face centered cubic lattice is 10% or less.

4. A tunneling magneto-resistance element according to claim 2, wherein:
said antiferromagnetic layer is formed of an antiferromagnetic material capable of being improved in the unidirectional anisotropy by being oriented in a (111) plane direction of a face centered cubic lattice; and
said lower shield layer is formed in a manner that an orientation rate between a (200) plane direction and the (111) plane direction of the face centered cubic lattice is 10% or less.

5. A manufacturing method of a tunneling magneto-resistance element comprising the steps of:
forming a seed layer by sputtering on a substrate, the seed layer being oriented in a plane orientation direction identical to a plane orientation direction of an antiferromagnetic layer that causes a unidirectional anisotropy to be improved;
forming a lower shield layer by applying electrolytic plating on the seed layer; and
depositing the antiferromagnetic layer on the lower shield layer.

6. A manufacturing method for a tunneling magneto-resistance element, according to claim 5,
wherein in the step of forming the seed layer by sputtering on the substrate, a vacuum degree in a sputtering chamber is set to 10⁻⁶ Pa.

7. A tunneling magneto-resistance element, comprising:
a pinned magnetic layer;
a free magnetic layer;
a tunnel barrier layer disposed to be interposed between said pinned magnetic layer and said free magnetic layer;
an antiferromagnetic layer that pins a magnetization direction of said pinned magnetic layer; and
a lower shield layer under said antiferromagnetic layer,
wherein said lower shield layer includes a sputter layer section and a lower-shield main section,
said sputter layer section is provided in contact with said antiferromagnetic layer and causes said antiferromagnetic layer to be oriented in a plane orientation direction that causes a unidirectional anisotropy of said antiferromagnetic layer to be improved, and
said lower-shield main section is provided under said sputter layer section and is formed of a same soft magnetic material as said sputter layer section.

8. A tunneling magneto-resistance element according to claim 7, further comprising:
an underlayer under the sputter layer section, wherein
said underlayer causes said sputter layer section to be oriented in a plane orientation direction identical to a plane orientation direction that causes the unidirectional anisotropy of said antiferromagnetic layer to be improved, and
said lower-shield main section is provided under said underlayer.

9. A tunneling magneto-resistance element according to claim 7, wherein
said antiferromagnetic layer is formed of an antiferromagnetic material capable of being improved in the unidirectional anisotropy by being oriented in a (111) plane direction of a face centered cubic lattice; and
said sputter layer section is formed in a manner that an orientation rate between a (200) plane direction and the (111) plane direction of the face centered cubic lattice is 10% or less.

10. A tunneling magneto-resistance element according to claim 8, wherein
said antiferromagnetic layer is formed of an antiferromagnetic material capable of being improved in the unidirectional anisotropy by being oriented in a (111) plane direction of a face centered cubic lattice; and
said sputter layer section is formed in a manner that an orientation rate between a (200) plane direction and the (111) plane direction of the face centered cubic lattice is 10% or less.

11. A manufacturing method of a tunneling magneto-resistance element comprising the steps of:
forming a seed layer by sputtering on a substrate, the seed layer being oriented in a plane orientation direction identical to a plane orientation direction of an antiferromagnetic layer that causes a unidirectional anisotropy to be improved;
forming a lower shield layer by applying electrolytic plating on the seed layer; and
depositing the antiferromagnetic layer on the lower shield layer,
forming a lower-shield main section by applying thereonto electrolytic plating on the seed layer;
forming an underlayer by sputtering on the lower-shield main section, the underlayer being oriented in a plane orientation direction identical to a plane orientation direction that causes a unidirectional anisotropy of the antiferromagnetic layer to be improved;
forming on the underlayer a sputter layer section that is formed of a same material as the lower-shield main section and that is oriented in a plane orientation direction identical to the plane orientation direction that causes the unidirectional anisotropy of the antiferromagnetic layer to be improved; and
depositing the antiferromagnetic layer on the sputter layer.

12. A magnetic head, comprising:
a magnetic reading head including the tunneling magneto-resistance element according to claims 1.

13. A magnetic head, comprising:
a magnetic reading head including the tunneling magneto-resistance element according to claim 7.

14. A magnetic storage apparatus, comprising:
a magnetic head including the tunneling magneto-resistance element according to claims 1;
a head suspension attached to said magnetic head, having a flexibility; and
an actuator arm fixing an end of said suspension, flexibly pivoting.

15. A magnetic storage apparatus, comprising:
a magnetic head including the tunneling magneto-resistance element according to claims 7;
a head suspension attached to said magnetic head, having a flexibility; and
an actuator arm fixing an end of said suspension, flexibly pivoting.
